(19) United States
(12) Patent Application Publication
(10) Pub. No.: US 2024/0142964 A1
(43) Pub. Date: May 2, 2024

(54) METHOD OF IMPROVING A TIMING OF A PLANNED MAINTENANCE AND METHOD OF OPTIMIZING A MAINTENANCE

(71) Applicant: BUERKERT WERKE GmbH & CO., KG, Ingelfingen (DE)

(72) Inventor: Andreas UNGERER, Ingelfingen (DE)

(21) Appl. No.: 18/494,059

(22) Filed: Oct. 25, 2023

(30) Foreign Application Priority Data
Oct. 27, 2022 (DE) 102022128582.0

(51) Int. Cl. G05B 23/02

(52) U.S. Cl. CPC G05B 23/0283

(57) ABSTRACT

A method of improving a timing of a planned maintenance of a wear part in a device, in particular in an electropneumatic or electric motor-driven process valve, is provided. In a method step, at least one system value of the device, which is related to the wear of the wear part, is acquired by an acquisition device during operation of the device. The at least one system value is evaluated by an analysis unit and a maintenance time is determined by the analysis unit at which the wear part is to be replaced on the basis of the at least one system value. When the system value reaches a defined maintenance value, the wear part is replaced. The wear part replaced is assessed with regard to its wear and classified into one of three categories, a first category denoting too early a replacement of the wear part, a second category denoting a timely replacement of the wear part, and a third category denoting too late a replacement of the wear part. Based on the categorization of the wear part, the maintenance value is redetermined by the analysis unit, wherein the redetermined maintenance value constitutes a recommendation for the next maintenance time. Furthermore, a method of optimizing a maintenance of a device or a process plant having a plurality of devices and a device having a wear part are indicated.

### TECHNICAL FIELD

The disclosure relates to a method of improving a timing of a planned maintenance of a wear part in a device, in particular in an electropneumatic or electric motor-driven process valve, and to a method of optimizing a maintenance of a device or a process plant including a plurality of devices, in particular process valves, in which at least two wear parts are replaced.

### BACKGROUND

Process valves contain wear parts that have to be replaced at regular intervals in order to ensure reliable functioning of the valve. Such wear parts include, for example, a sealing diaphragm, a packing gland, or a valve seat set. Other devices such as, e.g., flow sensors, also contain wear parts, for example, an impeller.

Since these valve parts are not visible during regular operation of a process valve, maintenance intervals are scheduled, with the respective wear part being replaced at the end of a maintenance interval.

A challenge here is to schedule the maintenance intervals precisely such that the respective wear part is replaced neither too early nor too late, particularly since wear depends on the most varied of process parameters, such as the media temperature, the medium used, the pressure conditions in the valve, etc. Too early a replacement will lead to increased costs because the wear part will be replaced more often than necessary and also because a plant containing the wear part will be in a maintenance operation more frequently, which results in an increase in downtimes. Too late a replacement, on the other hand, may result in the wear part already being defective when it is replaced, which may have an adverse effect on a process.

If a plurality of wear parts are provided in a process valve or in a process plant, it is a further challenge to plan the maintenance intervals such that, as far as possible, different wear parts can be replaced in one maintenance without individual wear parts being replaced excessively early or excessively late.

It is therefore an object to optimize a timing of a planned maintenance.

### SUMMARY

The disclosure provides a method of improving a timing of a planned maintenance of a wear part in a device, in particular in an electropneumatic or electric motor-driven process valve. In one method step, at least one system value of the device, which is related to the wear of the wear part, is acquired by an acquisition device during operation of the device. The at least one system value is evaluated by an analysis unit and a maintenance time is determined by the analysis unit at which the wear part is to be replaced on the basis of the at least one system value. When the system value reaches a defined maintenance value, the wear part is replaced. The replaced wear part is assessed with regard to its wear and is classified in one of three categories, a first category denoting too early a replacement of the wear part, a second category denoting a timely replacement of the wear part, and a third category denoting too late a replacement of the wear part. Based on the categorization of the wear part, the maintenance value is redetermined by the analysis unit, wherein the redetermined maintenance value constitutes a recommendation for the next maintenance time.

A subsequent maintenance is performed when the newly determined maintenance value has been reached.

The analysis unit may determine the maintenance time based on the defined maintenance value respectively the redetermined maintenance value.

The advantage of the method according to the disclosure is that the duration of the maintenance interval approaches more and more closely to an optimum over time. What is meant by this is that maintenance takes place as far as possible exactly when the wear part being replaced is replaced neither too early nor too late, i.e. that the wear part replaced is classified in the second category.

The system value is, for example, a totalizer, which means that a value increases continuously, such as for example a distance covered by a drive or a number of operating hours.

During first-time operation, the first maintenance value is set, for example, by a user, e.g. based on empirical values.

Aside from a process valve, the device may also be a flow sensor or an actuator.

The wear part is, for example, a sealing diaphragm, a packing gland, a valve seat set, an impeller or a supercapacitor, and the system value may be an operating time, a number of cycles, an end of travel position, a distance traveled by a drive element and/or a number of changes in direction of a drive element, or system values based on different parameters may be provided, on each of which separate maintenance values are based.

Sealing diaphragms, packing glands and valve seat sets are wear parts of a process valve, e.g. of an electropneumatic process valve, which in comparison to other parts of the process valve are subject to particularly high wear and have to be replaced correspondingly frequently. Electric motor driven process valves additionally have a supercapacitor as an energy storage device, which is also subject to wear. An impeller, for example, is a wear part of a flow sensor that is in contact with media and subject to high wear. Therefore, if the maintenance intervals are improved for these parts, there is a particularly high potential for cost savings.

The system values mentioned are directly or indirectly associated with the service life of the respective wear part and therefore allow conclusions to be drawn about the condition of the wear part.

By providing system values based on different parameters, on each of which separate maintenance values are based, different system values influencing wear can be considered separately.

The assessment for categorizing the wear part is performed by a service technician, for example. In doing so, the service technician assesses the wear part based on his or her experience or by comparing the wear part with comparative images.

As an alternative, the categorization may be effected by means of a visual acquisition unit that visually acquires the wear part that has been replaced, compares the acquired image data with image data stored in a memory and, based on the comparison, assigns the wear part replaced to a first, a second or a third category. By means of a visual acquisition unit, the categorization may happen in an automized manner and may be particularly accurate.

The categorization may also be performed using artificial intelligence.

The categorization of the wear parts replaced may be carried out taking into account a medium used, a temperature prevailing in the device and/or prevailing process conditions. This means that a different categorization may be performed in different devices with exactly the same condition of the wear part as a function of the existing operating and process conditions. In this way, the maintenance interval is matched to the field of application or the stress on the wear part.

One process condition, for example, is an acceptance of minor leakage.

According to one aspect, for each category separately the number of maintenance operations performed is counted in which the wear part is assigned to the respective category by the analysis unit. Based on the number of maintenance operations performed in the respective category, conclusions can be drawn about how convincing an average system value assigned to the respective category is.

For example, during each maintenance, the system value at which the maintenance is performed is acquired and is also assigned to the category corresponding to the state of the wear part by the analysis unit. The system values at which a maintenance was performed too early or too late or at exactly the right time are thus each collected separately. In this way, as the number of maintenance operations increases, for each category a range of the system value can be determined within which the wear part falls into the respective category. This allows a maintenance interval to be planned with particular precision. Based on the acquired ranges of the system value, it can be read off e.g. whether maintenance can still be delayed to some extent.

The ranges may partially overlap.

For example, a Gaussian curve of the system values is generated for each category. In this case, all system values are stored separately during each maintenance. This embodiment therefore lends itself to applications of the method outside the device, for example in a cloud, as a result of which sufficient storage space is available for saving the data acquired. The advantage of this embodiment is that the illustration using Gaussian curves is particularly convincing and overlaps can be displayed. This means that an optimum maintenance time can be determined particularly precisely.

An optimum maintenance time is located in a range around the maximum of the Gaussian curve of those system values that were assigned to the second category.

When taking multiple system values into account, a separate categorization can be performed for each system value. This allows different system values influencing wear to be considered separately.

According to one aspect, at least for the second category, a mean value serving as a maintenance value for the next maintenance interval is formed by the analysis unit from the system values that are assigned to the second category. After each maintenance, the maintenance value is thus redetermined based on all system values so far acquired in a category. This step is carried out by the analysis unit e.g. when a wear part has been assigned to the second category. If the wear part was assigned to the first or the third category, the mean value of the system values of the second category remains the same.

In the same way, a separate mean value may additionally also be formed by the analysis unit from the system values for the first and third categories, that is, for each category, of the system values assigned to the respective category. Based on the further mean values for the first and third categories, it can be read off when the maintenance is too early or too late. This knowledge is useful above all when a maintenance is to be brought forward or delayed to some extent, for example in order to replace a plurality of wear parts together during a maintenance.

In addition, the mean values of the first and third categories may be introduced in the determination of a new maintenance value, e.g. if the wear part was classified in the first or the third category during maintenance.

The object is furthermore achieved by a method of optimizing a maintenance of a device, in particular a process valve, or a process plant including a plurality of devices, in which at least two wear parts are replaced, wherein for the at least two wear parts of the device or the process plant, a timing of a planned maintenance is improved in accordance with a method according to the disclosure, and wherein, if different recommended maintenance times result for the two wear parts based on the respective maintenance values, a deviation from the recommended maintenance value is effected for at least one of the wear parts by the analysis unit. This allows the number of maintenance operations to be reduced, which also results in cost savings and reduced downtimes of the process valve or the process plant.

However, according to one option, exceeding the mean system value of the third category is not permissible. In this way, it is prevented that one of the wear parts will, already before maintenance, reach a state of wear that adversely affects operation of the process valve or the process plant.

The object is furthermore achieved by a device, in particular a process valve, including at least one wear part and including at least one analysis unit which is configured to evaluate system values of the device and to determine, on the basis of the system values acquired, a maintenance time in accordance with a method according to the disclosure, at which time the wear part is to be replaced.

The device may further include an acquisition device that is configured to acquire at least one system value of the device during the operation of the device.

### BRIEF DESCRIPTION OF THE DRAWINGS

FIG. 1 schematically shows a process plant having a plurality of process valves;

FIG. 2 schematically shows a process valve;

FIG. 3 shows a Gaussian distribution of an acquired system value for different categories;

FIG. 4 shows a chart for evaluating the maintenance values of diaphragms that have been replaced;

FIG. 5 shows a chart for illustrating a determination of a maintenance value;

FIG. 6 shows a drop-down menu of a user interface; and

FIG. 7 shows a maintenance assistant.

### DETAILED DESCRIPTION

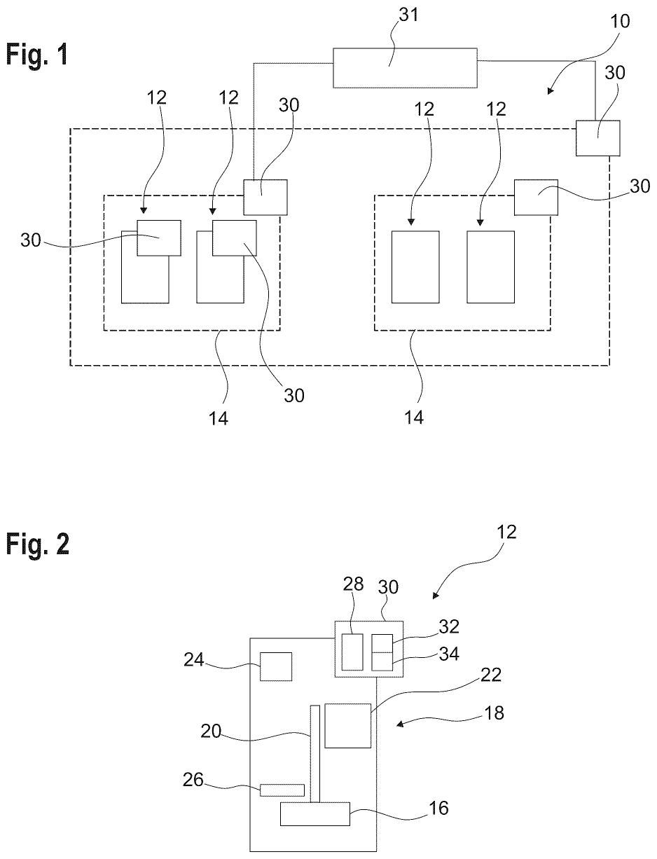

FIG. 1 schematically illustrates a process plant 10 comprising a plurality of devices 12, which in the exemplary embodiment represent process valves.

Multiple devices 12 are each optionally combined to form a device group 14, in particular a valve group.

As is schematically illustrated in FIG. 2, each device 12 has at least one wear part 16, which is, for example, a sealing diaphragm, a packing gland, a valve seat set, a supercapacitor or an impeller. In particular, the wear part 16 is a component that is in contact with media and/or subject to strong movement.

Furthermore, each device 12 has an acquisition device 18 for acquiring at least one system value during operation of the device 12.

The system values acquired may be an operating time, a number of cycles, an end of travel position, a distance traveled by a drive element 20 of the device 12, and/or a number of changes of direction of a drive element 20.

The acquisition device 18 illustrated in FIG. 2 comprises, by way of example, a position measuring system 22, an operating hours meter 24, and a position sensor 26. The acquisition device 18 may, however, comprise still further components in order to acquire additional system values, if required.

Moreover, each device 12 comprises an analysis unit 28, which is configured to evaluate the system values acquired.

On the basis of the system values acquired, the analysis unit 28 can, in particular, determine a maintenance time at which the wear part 16 is to be replaced, as will be discussed in detail below.

The analysis unit 28 may be part of a human-machine interface 30 or may be connected to such an interface 30 in terms of signaling.

For example, the human-machine interface 30 has a display unit 32 that is configured to display to a user a maintenance time of a wear part 16, and an input unit 34 that allows a user to input information, for example about a condition of a wear part 16 replaced.

The human-machine interface 30 comprises, for example, a touch screen that constitutes the display unit 32 and the input unit 34 at the same time.

Alternatively or additionally, if a plurality of devices 12 are combined to form a device group 14 in a process plant 10, a higher-level human-machine interface 30 may be provided for each device group 14.

Furthermore, an additional higher-level human-machine interface 30 may be provided at the process plant 10.

Optionally, a memory may be provided, in which the acquired system values and maintenance times are stored. The values stored in the memory can be read out, for example, in the context of long-term examinations.

The respective display unit 32 displays if and when a system value of the device 12, which is related to the wear of the wear part 16, reaches a defined maintenance value. In particular, in this case, a request is made to a user to replace the wear part 16.

A first maintenance value is, for example, initially fixed by a user during first-time operation of the device 12 or the process plant 10. It is also conceivable that a supplier of the process plant may suggest an initial maintenance value that is based on plant tests.

However, it is intended according to the disclosure that this maintenance value be adjusted over the course of the entire operating time of the device 12 or the process plant 10 in order to improve a duration of a planned maintenance interval of a wear part 16, so that the duration of the maintenance interval approaches an optimum more and more closely in the course of time and the replacement of the wear part 16 is performed at an optimum point in time.

To achieve this, at least one system value of the device 12 that is related to the wear of the wear part 16, in particular at least one of the aforementioned system values, is acquired during operation of the device 12.

The system value acquired is monitored and evaluated by the analysis unit 28.

In particular, the analysis unit 28 determines a maintenance time at which the wear part is to be replaced on the basis of the at least on system value.

When the system value reaches a defined maintenance value, the wear part 16 is replaced.

For example, a message is output by means of the display unit 32 indicating that the defined maintenance value has been reached and that replacement of the wear part 16 is required.

The wear part 16 that has been replaced is assessed with regard to its wear and is classified into one of three categories, with a first category denoting that the wear part has been replaced too early, a second category denoting a timely replacement of the wear part, and a third category denoting that the wear part has been replaced too late.

Based on the categorization of the wear part 16, the maintenance value is redetermined, with the redetermined maintenance value constituting a recommendation for the next maintenance point in time.

The determination of the maintenance value is performed, for example, by the analysis unit 28. For this purpose, an appropriate algorithm may be stored in the analysis unit 28.

In the depicted embodiment, the process plant 10 comprises a visual acquisition unit 31 that is configured to visually acquire a wear part 16 that has been replaced, compare the acquired image data with image data stored in a memory and, based on the comparison, assign the wear part replaced to the first, the second or the third category.

Alternatively, the classification can be performed by a user.

After a maintenance, the category of the replaced wear part 16 is entered, more particularly at the human-machine interface 30, so that the relevant information about the categorization can be passed on to the analysis unit 28.

If the classification is performed by the visual acquisition unit 31, the category of the replaced wear part 16 can be automatically transmitted to the analysis unit 28. In an alternative, a user can manually enter the respective category based on the output of the visual acquisition unit 31.

In one exemplary embodiment, a user removes the wear part 16 from the device 12, arranges the wear part 16 in the visual acquisition unit 31 for classification and enters the category displayed by the visual acquisition unit 31 at the human-machine interface 30.

The visual acquisition unit 31 may be a portable device or a fixed appliance.

In case of a portable device, the visual acquisition unit 31 can for example be connected to the human-interface machine 30 in such a way that data can be transferred.

The aforementioned steps are repeated each time the wear part 16 is replaced, that is, after each maintenance, an appropriate categorization of the wear part 16 replaced is performed and the maintenance value is redetermined, in particular by the analysis unit 28.

According to one embodiment, a plurality of different system values is acquired and a common maintenance value is formed based on the system values, in particular by the analysis unit 28.

As an alternative, system values based on different parameters are provided, on which respective separate maintenance values are based.

The categorization of the wear parts 16 replaced may be performed taking into account a medium used, a temperature prevailing in the process valve and/or prevailing process conditions. For this purpose, the device 12 may comprise a temperature sensor, a pH sensor and/or a pressure sensor, which are not shown in the figures for the sake of simplicity.

Moreover, the medium used, a temperature prevailing in the process valve, and further process and/or operating conditions can be taken into account when a device 12 is used in a different system with the same or similar operating conditions, by reusing the maintenance values when the operating conditions are the same.

In addition to the categorization of the wear part 16, the system value at which the maintenance is performed is recorded for each maintenance and also assigned to the category that corresponds to the condition of the wear part 16.

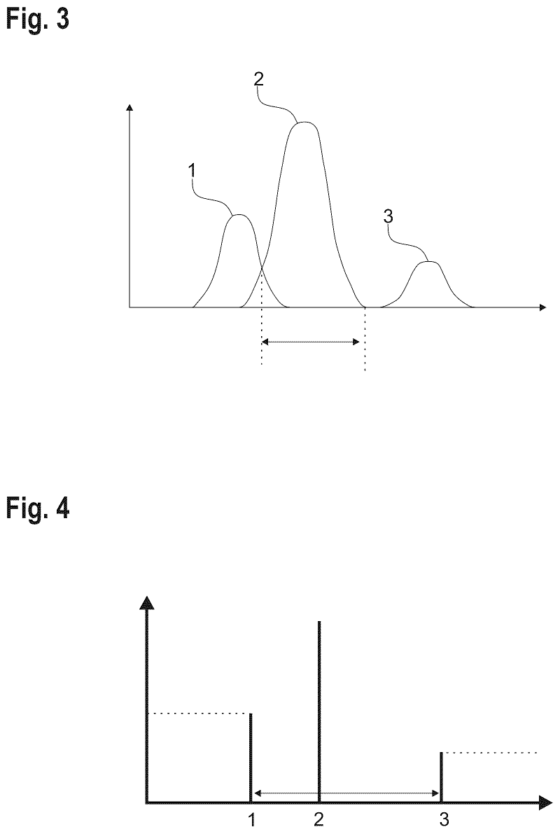

If the number of maintenance operations for each category is plotted against the system values recorded, as is illustrated in FIG. 3, a Gaussian curve is obtained for each category. In FIG. 3, the Gaussian curves are numbered according to their category.

Based on the Gaussian curve 2, a range can be read off in which maintenance should optimally take place.

Based on the Gaussian curves 1 and 3, a respective range can be read off in which a replacement of the wear part 16 is most likely performed too early or, respectively, too late.

The use of Gaussian curves allows the optimum time for maintenance to be determined with particular accuracy.

An alternative embodiment, simplified as compared to FIG. 3, for evaluating the system values and categorizing the wear parts 16 replaced is illustrated in FIG. 4 by means of a bar chart.

In the embodiment of the method illustrated in FIG. 4, for each category separately the number of maintenance operations carried out is counted, in which the wear part 16 is assigned to the respective category. In particular, in FIG. 4 the number of maintenance operations performed in each category 1, 2, 3 is plotted, the categorization reflecting the degree of wear of the wear part 16.

In particular, an optimum maintenance time is located in a range between category 1 and category 3, more precisely in the range adjacent to the bar of category 2.

In particular, the position of the bar of category 2 represents a current maintenance value. Consequently, when the maintenance value changes, the bar shifts to the left or right along the axis of the chart.

To determine a new maintenance value, for example, after a replacement of the wear part 16, a mean value is formed for the second category from the system values that are assigned to the second category, this mean value serving as a maintenance value for the next maintenance interval. More precisely, a new maintenance value is calculated in this way each time the previously replaced diaphragm has been classified in category 2.

For example, the maintenance value is calculated in accordance with the following formula:

maintenance valueₜ₊₁=((number of maintenance operations)ₜ₋₁*(mean value of maintenance value)ₜ₋₁+maintenance valueₜ)*1/(number of maintenance operations)ₜ₋₁+1 maintenance operation

In this context, t stands for a current or most recent maintenance interval, t−1 stands for a previous maintenance interval, and t+1 stands for a future maintenance interval. The formula constitutes a modified variant for calculating the mean value of the system values acquired in the second category, with the advantage being obtained that it is not required to permanently store the individual system values, but only a mean value of the maintenance value and the number of maintenance operations. This provides for a reduction in the required storage capacity of the device 12.

In the same way, a separate mean value is formed from the system values for the first and third categories from the system values that are assigned to the respective category.

By acquiring the system values also for the first and third categories, a condition of a wear part 16 can be estimated even better.

For example, a signal is already provided to the user when the system value of category 1 is reached, to advise the user that replacement of the wear part 16 is required soon.

Should a user have missed maintenance at the maintenance time, a further signal may be output when the system value of category 3 is reached, to advise the user that maintenance is urgently required.

If a wear part 16 that has been replaced is classified in category 1 or 3, the calculation of the new maintenance value is performed in an alternative manner. In particular, the mean value of the system value of category 2 does not change when the wear part 16 replaced is classified in category 1 or 3, so that in this case no improvement of the maintenance interval can be achieved by recalculating the mean value of category 2.

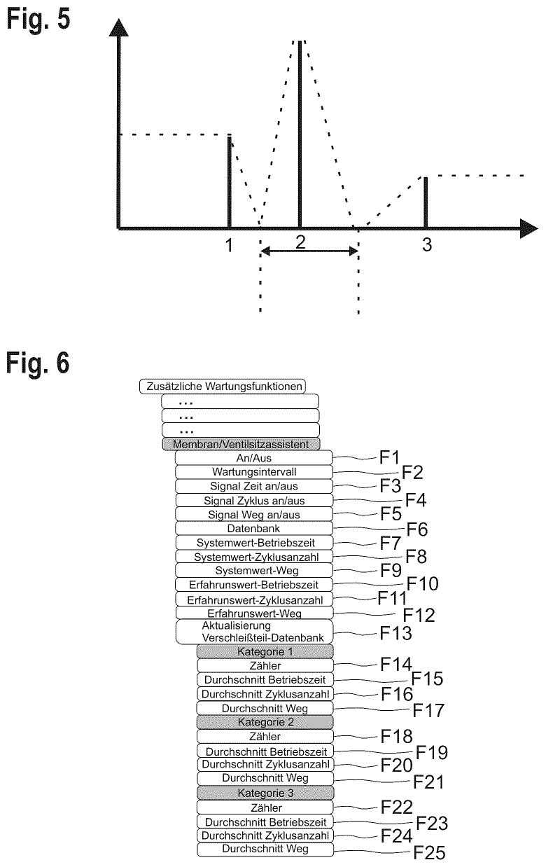

The procedure for determining a new maintenance value for the next maintenance interval in the case that the wear part 16 has been classified in category 1 or 3 is illustrated in FIG. 5.

If the replaced wear part 16 is classified in category 1, the maintenance value for the next maintenance interval is determined by taking the mean value of the average of the system values of category 2 and the average of the system values of category 1. In reference to FIG. 5, this means that the new maintenance value is midway between the bar of category 1 and the bar of category 2.

If the replaced wear part 16 is classified in category 3, the maintenance value for the next maintenance interval is determined in the same way, by taking the mean value of the average of the system values of category 2 and the average of the system values of category 3.

It is also possible for a spread of the optimum maintenance time to be taken into account, that is, a range is determined in which the optimum maintenance value is located with a high probability.

In this case, a lower limit of the maintenance time is calculated as follows:

(system value category1+(system value category2−system value category1))/2

An upper limit of the maintenance time is calculated as follows:

(system value category2+(system value category3−system value category 2))/2

In case of doubt, too early a maintenance is preferable to too late a maintenance.

It is conceivable that a plurality of different system values are taken into account, with a separate categorization being performed for each system value.

A maintenance interval can in this case be determined based on different system values.

In this case, a user can specify according to which prioritization the system values are taken into account.

For example, it may be specified that maintenance is always performed as early as possible, i.e. when one of the system values reaches the maintenance value. This is reasonable in particular for processes in which wear of the wear part 16 is very critical.

For less critical processes, it may be specified that maintenance is carried out when at least two system values, for example half of all system values monitored, have reached their respective maintenance value.

For processes in which wear of the wear part 16 is relatively uncritical, maintenance is performed, for example, when all system values monitored have reached their respective maintenance values.

If a device 12 has a plurality of wear parts 16, or in a process plant 10 with a plurality of devices 12, the acquisition of the system values and the relative categorization can also serve to optimize maintenance in which at least two wear parts are replaced.

In the case of process plants 10 or devices 12 having a plurality of wear parts, it is more particularly not efficient to perform maintenance separately for each individual wear part 16, since this also involves downtimes of the process plant 10 or the device 12. Instead, it is advantageous if a plurality of wear parts 16 are exchanged during a single maintenance.

In order to optimize maintenance accordingly for a plurality of wear parts 16, a deviation from the recommended maintenance value occurs for at least one of the wear parts 16 if a different recommended maintenance time results for at least two wear parts 16 based on the respective maintenance values.

However, exceeding the mean system value of the third category is not permissible here in order to avoid impairment of the process.

The method described above is applied in particular in a so-called wear part assistant.

A user interface of such a wear part assistant is illustrated in FIG. 6. More precisely, FIG. 6 illustrates an example of a drop-down menu of a wear part assistant for the “sealing diaphragm” wear part.

The user interface is depicted, for example, on the display unit 32.

By actuating field F1, the user can activate or deactivate the wear part assistant for the wear part 16 in question.

In field F2, the user can have a maintenance interval displayed to him/her.

In fields F3, F4, F5, a user can set which system values are to be acquired. In the example illustrated, the user has the options of operating time, number of cycles and/or a distance traveled by a drive element 20 to choose from. However, further system values are possible.

In field F6, the user can access a database, in which the values acquired in the past are stored. In particular, the database has values stored therein based on which a user can manually enter a maintenance value.

By activating the fields F7, F8, F9 a user can have the respective current system values displayed. In particular, totalizers are displayed there. The values are reset after the wear part has been replaced.

In fields F10, F11, F12, a user can enter his or her own empirical values, for example an initial maintenance value.

Under field F13, a further menu opens in which a user can define whether or not the maintenance values are to be updated.

In field F14, the user can call up a counter that indicates how often a wear part 16 replaced has already been classified in category 1.

In fields F15, F16, F17, the average values of the system values of operating time, number of cycles and distance traveled can be retrieved, which have been assigned to category 1 accordingly.

In fields F18, F19, F20, F21 the respective values for category 2 can be called up and in fields F22, F23, F24, F25 the respective values for category 3.

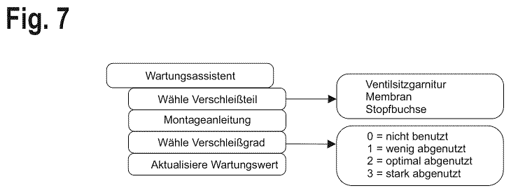

FIG. 7 illustrates a maintenance assistant that can be displayed on the display unit 32 during maintenance.

In the maintenance assistant, a user can select a wear part 16 to be replaced, download corresponding installation instructions, perform a categorization based on the degree of wear. The categorization entered can subsequently be processed in the maintenance assistant to update the maintenance value.

1. A method of improving a timing of a planned maintenance of a wear part in a device, comprising the steps of:
acquiring at least one system value of the device, which is related to the wear of the wear part, by an acquisition device during operation of the device;
evaluating the at least one system value by an analysis unit;
determine a maintenance time by the analysis unit at which the wear part is to be replaced on the basis of the at least one system value;
replacing the wear part when the system value reaches a defined maintenance value;
assessing the replaced wear part with regard to its wear and classifying it into one of three categories, a first category denoting too early a replacement of the wear part, a second category denoting a timely replacement of the wear part, and a third category denoting too late a replacement of the wear part;
redetermining the maintenance value based on the categorization of the wear part by the analysis unit, wherein the redetermined maintenance value constitutes a recommendation for the next maintenance time.

2. The method according to claim 1, characterized in that the method is carried out for an electropneumatic or electric motor-driven process valve.

3. The method according to claim 1, wherein the wear part is a sealing diaphragm, a packing gland, a valve seat set, an impeller or a supercapacitor.

4. The method according to claim 1, wherein the system value is an operating time, a number of cycles, an end of travel position, a distance covered by a drive element and/or a number of changes in direction of a drive element.

5. The method according to claim 1, wherein system values based on different parameters are provided, on each of which separate maintenance values are based.

6. The method according to claim 1, wherein the categorization is performed by means of a visual acquisition unit that visually acquires the wear part that has been replaced, compares the acquired image data with image data stored in a memory and, based on the comparison, assigns the wear part replaced to a first, a second or a third category.

7. The method according claim 1, wherein the categorization of the replaced wear parts is performed taking into account a medium used, a temperature prevailing in the device and/or prevailing process conditions.

8. The method according to claim 1, wherein for each category separately the number of maintenance operations carried out is counted in which the wear part is assigned to the respective category by the analysis unit.

9. The method according to claim 1, wherein during each maintenance the system value, at which the maintenance is performed, is acquired and is also assigned to the category corresponding to the condition of the wear part by the analysis unit.

10. The method according to claim 9, wherein system values based on different parameters are provided, on each of which separate maintenance values are based, and wherein, when taking into account a plurality of system values, a separate categorization is performed for each system value.

11. The method according to claim 9, wherein at least for the second category a mean value serving as a maintenance value for the next maintenance interval is formed by the analysis unit from the system values that are assigned to the second category.

12. The method according to claim 9, wherein a separate mean value is formed by the analysis unit from the system values for each category of the system values that are assigned to the respective category.

13. A method of optimizing a maintenance of a device comprising a plurality of devices, in which at least two wear parts are replaced, wherein for the at least two wear parts of the device or the process plant, a timing of a planned maintenance is improved in accordance with a method according to claim 1, and wherein, if different recommended maintenance times result for the two wear parts based on the respective maintenance values, a deviation from the recommended maintenance value is effected for at least one of the wear parts by the analysis unit.

14. The method according to claim 13 and additionally according to claim 8, wherein exceeding the mean system value of the third category is not permissible.

15. A device comprising at least one wear part and comprising at least one analysis unit which is configured to evaluate system values of the device and to determine, on the basis of the system values acquired, a maintenance time in accordance with a method according to claim 1 at which time the wear part is to be replaced.

16. The device according to claim 15, wherein the device is a process valve.
